(19) United States
(12) Patent Application Publication
(10) Pub. No.: US 2006/0185168 A1
(43) Pub. Date: Aug. 24, 2006

(54) Aluminum pipe and process for producing same

(75) Inventor: Teruki Morita, Tochigi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SHOWA DENKO K.K., TOKYO (JP)

(21) Appl. No.: 10/534,537

(22) PCT Filed: Nov. 12, 2003
(86) PCT No.: PCT/JP03/14347

§ 371 Date: May 12, 2005

Related U.S. Application Data
(60) Provisional application No. 60/429,541, filed on Nov. 29, 2002.

(30) Foreign Application Priority Data
Nov. 12, 2002 (JP) 2002-328800

(51) Int. Cl. B23P 15/26; B21D 21/00

(52) U.S. Cl. 29/890.053; 420/528

(57) ABSTRACT

An inlet pipe 6 and an outlet pipe 7 for a condenser are made from an alloy containing 0.9 to 1.5 mass % of Mn, and the balance Al and inevitable impurities. Each of the inlet pipe 6 and the outlet pipe 7 contains Zn diffused through a surface layer portion thereof from the outermost surface of outer periphery of the pipe to a depth of at least 60 fÊm, and the surface layer portion has a Zn concentration of 0.20 to 0.70 mass %. The pipes 6 and 7 can be produced easily at a low cost and have satisfactory resistance to pitting corrosion.

### CROSS REFERENCE TO RELATED APPLICATIONS

This application is an application filed under 35 U.S.C. §111(a) claiming the benefit pursuant to 35 U.S.C. §119 (e) (1) of the filing data of Provisional Application No. 60/429, 541 filed Nov. 29, 2002 pursuant to 35 U.S.C. §111(b).

### TECHNICAL FIELD

The present invention relates to aluminum pipes and a process for producing the pipe, and more particularly to aluminum pipes useful as inlet pipes and outlet pipes in heat exchanges, such as condensers or evaporators for motor vehicle air conditioners wherein a chlorofluorocarbon refrigerant is used, gas coolers or evaporators for motor vehicle air conditioners wherein CO₂ refrigerant is used, motor vehicle oil coolers and motor vehicle radiators; as pipes for piping in motor vehicle air conditioners which have a refrigeration cycle adapted for use with a chlorofluorocarbon refrigerant, the refrigeration cycle comprising a compressor, condenser and evaporator which are interconnected by the piping; and as pipes for piping in motor vehicle air conditioners which have a refrigeration cycle adapted for use with CO₂ refrigerant, the refrigeration cycle comprising a compressor, gas cooler, intermediate heat exchanger, expansion valve and evaporator which are interconnected by the piping, and also to a process for producing such pipes.

The term “aluminum” as used herein and in the appended claims includes aluminum alloys in addition to pure aluminum. Incidentally, an atomic symbol representing a metal of course does not include alloys thereof.

### BACKGROUND ART

Condensers are known for use in motor vehicle air conditioners comprising a refrigeration cycle-wherein a chlorofluorocarbon refrigerant is used. Such condensers comprise a pair of aluminum headers arranged in parallel as spaced apart from each other, parallel flat heat exchange tubes made of aluminum and joined at their opposite ends to the headers, a corrugated aluminum fin disposed in an air passage clearances between each pair of adjacent heat exchange tubes and brazed to the pair of heat exchange tubes, an inlet pipe of aluminum connected to one of the headers and an outlet pipe of aluminum connected to the other header.

The inlet pipe and the outlet pipe of the condenser described are conventionally produced, for example, from JIS A1100, JIS A3003 or an alloy containing 1.0 to 1.5 mass % of Mn, at least 0.2 mass % to less than 0.6 mass % of Mg, and the balance Al and inevitable impurities (see the publication of JP-B No. 1991-22459).

With the condenser described, the surfaces of the components are usually subjected to a chromate treatment so as to give improved corrosion resistance to the condenser. However, the treatment requires cumbersome work. Furthermore, Cr⁶⁺ is harmful and necessitates a troublesome waste liquid treatment. The condenser therefore has the problem of being cumbersome to fabricate in its entirety. Moreover, use of Cr⁶⁺ is to be prohibited in the near future in Europe.

For refrigerant tubes for use in the condenser, accordingly, studies are under way on various treatments for giving resistance to pitting corrosion and materials having pitting corrosion resistance as substitutes for the chromate treatment wherein harmful Cr⁶⁺ is used.

However, inlet and outlet pipes still remain to be developed which can be produced easily at a low cost and which have sufficient resistance to pitting corrosion. Of course, pitting corrosion resistance can not be expected of the inlet and outlet pipes disclosed in the above publication for use in heat exchangers, unless they are subjected to the chromate treatment.

An object of the present invention is to overcome the above problem and to provide an aluminum pipe which has satisfactory resistance to pitting corrosion and which can be produced easily at a lost cost, and a process for producing the pipe.

### DISCLOSURE OF THE INVENTION

The present invention provides an aluminum pipe made from an alloy containing 0.9 to 1.5 mass % of Mn, and the balance Al and inevitable impurities, the pipe containing Zn diffused through a surface layer portion thereof from the outermost surface of an outer periphery of the pipe to a depth of at least 60 μm, the surface layer portion having a Zn concentration of 0.20 to 0.70 mass %.

With the aluminum pipe of the present invention, Mn produces an effect to give the pipe improved resistance to pitting corrosion and improves the strength of the pipe for use as an inlet pipe or outlet pipe of for heat exchangers. If the Mn content is less than 0.9 mass %, this effect is not available. If more than 1.5 mass % of Mn is present, the effect to give an improved strength levels off, while hot working involves increased resistance to deformation to result in impaired workability, for example, lower extrudability, when the pipe is to be produced as the inlet or outlet pipe for use in heat exchangers. Accordingly, the Mn content of the inlet or outlet pipe should be 0.9 to 1.5 mass %, and is preferably 1.0 to 1.2 mass %.

The Zn diffused through a surface layer portion of the aluminum pipe of the invention from the outermost surface of the outer periphery thereof to a depth of at least 60 μm gives a base potential to this portion, permitting the portion of the pipe other than the surface layer portion to undergo sacrificial corrosion to prevent the aluminum pipe from developing pitting corrosion. However, if the Zn concentration of the surface layer portion is less than 0.20 mass %, this effect is not available. Conversely, presence of more than 0.70 mass % of Zn causes no problem to the corrosion resistance of the aluminum pipe itself, but increasing the Zn concentration to more than 0.70 mass % requires thermal spraying of an increased amount of Zn on the surfaces of heat exchange tubes in the case where the aluminum pipe is to be produced simultaneously when the heat exchange tubes are brazed to fins to fabricate a heat exchanger as will be described later. It is then impossible to give the desired corrosion resistance to the heat exchange tubes of the exchanger to be obtained and to the brazed joints between the tubes and the fins. Accordingly, the surface layer portion should be 0.20 to 0.70 mass % in Zn concentration. Incidentally, the distance over which Zn is to be diffused into the pipe is limited to a maximum of about 100 μm as measured from the outermost surface of the outer periphery of the aluminum tube.

The aluminum pipe of the present invention can be prevented from pitting without being subjected to the chromate treatment. Moreover, the pipe is made from an alloy containing 0.9 to 1.5 mass % of Mn, and the balance Al and inevitable impurities and contains Zn diffused through a surface layer portion thereof from the outermost surface of outer periphery of the pipe to a depth of at least 60 μm, the surface layer portion having a Zn concentration of 0.20 to 0.70 mass %. The pipe can therefore be produced easily at a lost cost.

Preferably, the aluminum pipe of the invention contains up to 0.01 mass % of Cu as an inevitable impurity since Cu as an inevitable impurity is likely to give the aluminum pipe impaired resistance to pitting corrosion even if present in a very small amount.

Preferably, the aluminum pipe of the invention contains up to 0.25 mass % of Fe as an inevitable impurity because Fe as an inevitable impurity is likely to give the aluminum pipe impaired resistance to pitting corrosion although less influential than Cu.

Preferably, the aluminum pipe of the invention contains up to 0.25 mass % of Si as an inevitable impurity because Si, like Fe, has the likelihood of giving the aluminum pipe lower resistance to pitting corrosion Preferably, the aluminum pipe of the invention contains up to 0.30 mass % of Mg as an inevitable impurity because Mg as an inevitable impurity is likely to impair the brazeability and workability of the material, e.g., extrudability, to result in an increased working cost.

The present invention provides a process for producing an aluminum pipe characterized in that a pipe blank made from an alloy containing 0.9 to 1.5 mass % of Mn, and the balance Al and inevitable impurities, and an aluminum material having 2.0 to 16.0 g/m² of a Zn spray layer formed over a surface thereof and 75 to 600 g in total amount of Zn are heated at 580 to 610° C. for 3 to 15 minutes in a furnace having an inert gas atmosphere.

In the aluminum pipe production process of the present invention, the Zn of the spray layer formed over the surface of the aluminum material evaporates when heated in the subsequent step and diffuses into the surface layer of outer periphery of the pipe blank. The Zn spray layer over the surface of the aluminum material is limited to 2.0 to 16.0 g/m² and to 75 to 600 g in total amount of Zn because if these amounts are less than the respective lower limit values, the surface layer portion of the aluminum pipe produced can not be given a Zn concentration of at least 0.20 mass %, and also because if the amounts are in excess of the respective upper limit values, the surface layer portion will be in excess of 0.70 mass % in Zn concentration.

Further if the heating temperature and the heating time are less than the respective lower limit values in the aluminum pipe production process of the present invention, it is impossible to sufficiently cause Zn to be evaporated from the spray layer and to be subsequently diffused through the surface layer portion of the pipe blank, failing to give a Zn concentration of at least 0.20 mass % to the surface layer portion of the aluminum pipe obtained. If the temperature and time are in excess of the respective upper limit values, the base aluminum material of fins or other components will melt, or the Zn thermally sprayed on the surfaces of heat exchange tubes will diffuse into the heat exchange tubes to excess, possibly giving rise to leakage due to corrosion, for example, when the aluminum pipe is produced simultaneously when the heat exchange tubes are brazed to the fins for fabricating a heat exchanger as will be described later. The heating temperature is preferably 585 to 605° C.

The aluminum pipe described above can be produced relatively easily and inexpensively by the process of the present invention.

In the aluminum pipe production process of the invention, the alloy for making the pipe blank contains preferably 1.0 to 1.2 mass % of Mn. The alloy for making the pipe blank contains preferably up to 0.01 mass % of Cu as an inevitable impurity. The alloy for making the pipe blank contains preferably up to 0.25 mass % of Fe as an inevitable impurity. The alloy for making the pipe blank contains preferably up to 0.25 mass % of Si as an inevitable impurity. Further the alloy for making the pipe blank contains preferably up to 0.30 mass % of Mg as an inevitable impurity.

In the aluminum pipe production process of the invention, the aluminum material is in the form of a plurality of heat exchange tubes for use in a heat exchanger, each of the heat exchange tubes having 2.0 to 16.0 g/m² of a Zn spray layer formed over a surface thereof, the Zn spray layers of all the heat exchange tubes over the surfaces thereof being 75 to 600 g in combined amount of Zn, the furnace being adapted to braze the heat exchange tubes, aluminum headers and aluminum fins, and the pipe blank is heated when the heat exchange tubes, the headers and the fins are brazed in the inert gas atmosphere. In this case, the aluminum pipe can be produced simultaneously when the heat exchanger is fabricated, and can therefore be produced at a reduced cost, for example, without necessitating any special equipment.

### BRIEF DESCRIPTION OF THE DRAWINGS

FIG. 1 is a perspective view showing a condenser for use in motor vehicle air conditioners wherein a chlorofluorocarbon refrigerant is used, the condenser having an inlet pipe and an outlet pipe each of which is an aluminum pipe of the invention.

### BEST MODE OF CARRYING OUT THE INVENTION

An embodiment of the invention will be described below with reference to the drawing.

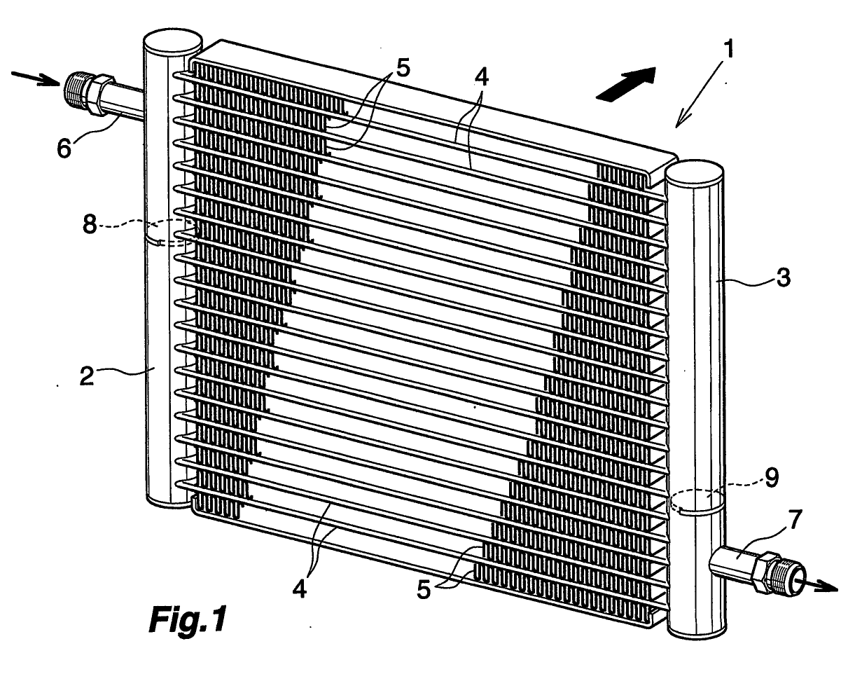

With reference to FIG. 1, a condenser 1 for use in motor vehicle air conditioners wherein a chlorofluorocarbon refrigerant is used comprises a pair of aluminum headers 2, 3 arranged in parallel and spaced apart from each other, parallel flat refrigerant tubes 4 (heat exchange tubes) made of aluminum extrudate and each joined at its opposite ends to the two headers 2, 3, corrugated fins 5 of aluminum brazing sheet each disposed in an air passage clearance between the adjacent refrigerant tubes 4 and brazed to the adjacent tubes 4, an inlet pipe 6 made of aluminum extrudate and connected to the upper end of peripheral wall of the first 2 of the headers, an outlet pipe 7 made of aluminum extrudate and connected to the lower end of peripheral wall of the second 3 of the headers, a first partition 8 provided inside the first header 2 and positioned above the midportion thereof, and a second partition 9 provided inside the second header 3 and positioned below the midportion thereof. The refrigerant tube 4 to be used may be an electro-resistance welded tube.

The number of refrigerant tubes 4 between the inlet pipe 6 and the first partition 8, the number of refrigerant tubes 4 between the first partition 8 and the second partition 9 and the number of refrigerant tubes 4 between the second partition 9 and the outlet pipe 7 decreasing from above downward to provide groups of channels. A refrigerant flowing into the inlet pipe 6 in a vapor phase flows zigzag through units of channel groups in the condenser before flowing out from the outlet pipe 7 in a liquid phase.

Each of the inlet pipe 6 and the outlet pipe 7 is made from an alloy containing 0.9 to 1.5 mass % of Mn, and the balance Al and inevitable impurities. The pipe contains Zn diffused through a surface layer portion thereof from the outermost surface of an outer periphery of the pipe to a depth of at least 60 μm, and the surface layer portion is 0.20 to 0.70 mass % in Zn concentration.

The alloy for making the inlet pipe 6 and the outlet pipe 7 has an Mn content preferably of 1.0 to 1.2 mass %. Among the inevitable impurities in the alloy, Cu is contained in an amount of up to 0.01 mass %, Fe is present in an amount of up to 0.25 mass %, Si in an amount of up to 0.25 mass %, and Mg in an amount of up to 0.30 mass %.

The inlet pipe 6 and the outlet pipe 7 are produced, for example, in the following manner.

First, the alloy described is extruded into an inlet pipe blank and an outlet pipe blank. Also prepared are a pair of aluminum headers 2, 3, a plurality of refrigerant tubes 4 made of aluminum extrudates, and a plurality of corrugated fins 5 made of aluminum brazing sheet for fabricating the condenser 1 shown in FIG. 1. A plurality of tube inserting holes are formed in each of the two headers 2, 3. A Zn spray layer is formed over the surface of each of the refrigerant tubes 4 in an amount of 2.0 to 16.0 g/m², preferably 2.0 to 8.0 g/m², and all the refrigerant tubes 4 are made to have over the surfaces thereof the respective Zn spray layers in a combined amount of 75 to 600 g, preferably 75 to 300 g.

The pair of headers 2, 3 are then arranged as spaced apart, the refrigerant tubes 4 and the corrugated fins 5 are arranged alternately, and opposite ends of the tubes 4 are inserted into the tube inserting holes of the headers 2, 3 to prepare an assembly. A fluoride flux (having a composition similar to a eutectic composition of potassium fluoride and aluminum fluoride) is thereafter applied to the assembly. The resulting assembly is placed into a furnace having an inert gas atmosphere along with the inlet pipe blank and the outlet pipe blank, followed by heating at 580 to 610° C. for 3 to 15 minutes. In this way, the refrigerant tubes 4 are brazed to the headers 2, 3 utilizing a brazing material layer on the headers 2, 3, and each pair of adjacent refrigerant tubes 4 to the corrugated fin 5 at the same utilizing the brazing material of the fin 5. The inlet pipe 6 and the outlet pipe 7 are produced simultaneously with the fabrication of the condenser 1.

The condenser 1 and a compressor and evaporator provide a refrigeration cycle wherein a chlorofluorocarbon refrigerant is used and which is installed in a vehicle, such as a motor vehicle, as an air conditioner.

The aluminum pipe of the invention according to the foregoing embodiment is used as the inlet pipe and outlet pipe of the condenser of a motor vehicle air conditioner comprising a refrigeration cycle wherein a chlorofluorocarbon refrigerant is used. Alternatively, the aluminum pipe may be used as the inlet pipe and outlet pipe of the evaporator of the motor vehicle air conditioner. Furthermore, the aluminum pipe of the invention may be used as the inlet and outlet pipes of heat exchangers for use as motor vehicle oil coolers, motor vehicle radiators, etc.

Additionally, the aluminum pipe of the invention is useful for piping in motor vehicle air conditioners which have a refrigeration cycle adapted for use with a chlorofluorocarbon refrigerant, the refrigeration cycle comprising a compressor, condenser and evaporator which are interconnected by piping, and for piping in motor vehicle air conditioners which have a refrigeration cycle adapted for use with CO₂ refrigerant, the refrigeration cycle comprising a compressor, gas cooler, intermediate heat exchanger, expansion valve and evaporator which are interconnected by piping.

The aluminum pipe of the invention may further be used in motor vehicle air conditioners which have a refrigeration cycle adapted for use with CO₂ refrigerant and comprising a compressor, gas cooler, intermediate heat exchanger, expansion valve and evaporator, as the inlet and outlet pipes of the gas cooler and the evaporator.

### EXAMPLE 1

An alloy containing 1.08 mass % of Mn, less than 0.01 mass % of Cu, 0.06 mass % of Si, 0.12 mass % of Fe, 0.01 mass % of Mg, 0.01 mass % of Cr, less than 0.01 mass % of Ti and less than 0.01 mass % of Zn, and the balance Al and inevitable impurities was extruded into 50 inlet pipe blanks, 12.7 mm in outside diameter and 1.2 mm in the wall thickness of peripheral wall and 50 outlet pipe blanks, 9.53 mm in outside diameter and 1.0 mm in the wall thickness of peripheral wall. The inlet pipe blanks were each 539 mm in length. The outlet pipe blanks were each 439 mm in length. All the inlet pipe blanks and outlet pipe blanks had a combined outer peripheral surface area of 1.732 m².

On the other hand, 1750 flat refrigerant tubes 4 made of aluminum extrudate and having an outer peripheral surface area of 0.0219 m² were prepared, and 8 g/m² of a Zn spray layer was formed over the outer periphery of each tube 4. The Zn spray layers over the outer peripheries of all the refrigerant tubes 4 were 306.6 g in combined amount of Zn.

Also prepared were 35 pairs of aluminum headers 2, 3 each having 35 tube inserting holes, and 1800 corrugated fins 5 made of aluminum blazing sheet and each having brazing material layer on opposite sides thereof.

One pair of headers 2, 3 were then arranged as spaced apart, the refrigerant tubes 4, 35 in number, and the corrugated fins 5, 36 in number, were arranged alternately, with the fin 5 positioned at each of opposite ends of the arrangement, and opposite ends of the tubes 4 were inserted into the tube inserting holes of the headers 2, 3 to prepare an assembly. Fifty assemblies were prepared in this way. A fluoride flux (having a composition similar to a eutectic composition of potassium fluoride and aluminum fluoride) was thereafter applied to these assemblies. The resulting assemblies were placed into a furnace having a nitrogen gas atmosphere. All the inlet pipe blanks and outlet pipe blanks were also placed into the furnace. The assemblies and the blanks were then heated from 30° C. to 580° C. at a rate of 56° C./min, held at 580° C. for 8.5 min and thereafter cooled to 300° C. at a cooling rate of 48° C./min and further cooled to 30° C. In this way, the refrigerant tubes 4 were brazed to the headers 2, 3 utilizing a brazing material layer on the headers 2, 3, and each pair of adjacent refrigerant tubes 4 to the corrugated fin 5 at the same utilizing the brazing material of the fin 5. Inlet pipes 6 and outlet pipes 7 are produced simultaneously with the fabrication of condensers 1.

### COMPARATIVE EXAMPLE 1

Inlet pipes and outlet pipes for condensers were produced in the same manner as in Example 1 with the exception of using inlet pipe blanks and outlet pipe blanks made of JIS A3003.

### COMPARATIVE EXAMPLE 2

Inlet pipes and outlet pipes for condensers were produced in the same manner as in Example 1 with the exception of using inlet pipe blanks and outlet pipe blanks made of JIS A1100.

### COMPARATIVE EXAMPLE 3

Inlet pipes and outlet pipes were produced by extruding the alloy of Example 1 without thereafter treating the extrudates in any way.

Evaluation Test 1

One pipe was taken out from among the inlet pipes produced in each of Example 1 and Comparative Examples 1 to 3, then subjected to SWAAT 960-hour test and checked for corrosion. Consequently, the inlet pipe of Example 1 developed corrosion to a maximum depth of 462 μm, but no pit was found extending through the peripheral wall of the pipe. On the other hand, the inlet pipes of Comparative Examples 1 to 3 developed pits extending through the peripheral wall.

Evaluation Test 2

Two inlet pipes and two outlet pipes were taken out from among the pipes produced in Example 1 and checked by an electron beam microanalyzer (EPMA) for a maximum distance of diffusion of Zn from the outermost peripheral surface and the Zn concentration at the maximum distance of diffusion. Table 1 shows the results. These inlet and outlet pipes were also subjected to SWAAT 960-hour test and checked for maximum depth of corrosion. Table 1 also shows the results.

TABLE 1

| | Sample | | Max. diffusion | Max. depth |
|---|---|---|---|---|
| | No. | Zn concn. | distance | of corrosion |
| Inlet pipe | 1 | 0.32 mass % | 65 μm | 206 μm |
| | 2 | 0.26 mass % | 65 μm | 231 μm |
| Outlet | 3 | 0.43 mass % | 70 μm | 521 μm |
| pipe | 4 | 0.43 mass % | 75 μm | 446 μm |

Evaluation Test 3

Two inlet pipes and two outlet pipes were taken out from among the pipes produced in Example 1, cleaned with an acid mixture and checked by an electron beam microanalyzer (EPMA) for a maximum distance of diffusion of Zn from the outermost peripheral surface and the Zn concentration at the maximum distance of diffusion. Table 2 shows the results. These inlet and outlet pipes were also subjected to SWAAT 960-hour test and checked for maximum depth of corrosion. Table 2 also shows the results.

TABLE 2

| | Sample | | Max. diffusion | Max. depth |
|---|---|---|---|---|
| | No. | Zn concn. | distance | of corrosion |
| Inlet pipe | 5 | 0.21 mass % | 70 μm | 462 μm |
| | 6 | 0.23 mass % | 60 μm | 159 μm |
| Outlet | 7 | 0.25 mass % | 65 μm | 120 μm |
| pipe | 8 | 0.28 mass % | 75 μm | 144 μm |

### INDUSTRIAL APPLICABILITY

The aluminum pipe of the present invention is suitable as inlet pipes and outlet pipes in heat exchanges, such as condensers or evaporators for motor vehicle air conditioners wherein a chlorofluorocarbon refrigerant is used, gas coolers or evaporators for motor vehicle air conditioners wherein CO₂ refrigerant is used, motor vehicle oil coolers and motor vehicle radiators; as pipes for the piping in motor vehicle air conditioners adapted for use with a chlorofluorocarbon refrigerant and comprising a compressor, condenser and evaporator which are interconnected by piping; and as pipes for piping in motor vehicle air conditioners adapted for use with CO₂ refrigerant and comprising a compressor, gas cooler, intermediate heat exchanger, expansion valve and evaporator which are interconnected by the piping.

1. An aluminum pipe made from an alloy containing 0.9 to 1.5 mass % of Mn, and the balance Al and inevitable impurities, the pipe containing Zn diffused through a surface layer portion thereof from the outermost surface of an outer periphery of the pipe to a depth of at least 60 μm, the surface layer portion having a Zn concentration of 0.20 to 0.70 mass %.

2. An aluminum pipe according to claim 1 wherein the Mn content is 1.0 to 1.2 mass %.

3. An aluminum pipe according to claim 1 which contains up to 0.01 mass % of Cu as an inevitable impurity.

4. An aluminum pipe according to claim 1 which contains up to 0.25 mass % of Fe as an inevitable impurity.

5. An aluminum pipe according to claim 1 which contains up to 0.25 mass % of Si as an inevitable impurity.

6. An aluminum pipe according to claim 1 which contains up to 0.30 mass % of Mg as an inevitable impurity.

7. A process for producing an aluminum pipe characterized in that a pipe blank made from an alloy containing 0.9 to 1.5 mass % of Mn, and the balance Al and inevitable impurities, and an aluminum material having 2.0 to 16.0 g/m² of a Zn spray layer formed over a surface thereof and 75 to 600 g in total amount of Zn are heated at 580 to 610° C. for 3 to 15 minutes in a furnace having an inert gas atmosphere.

8. A process for producing an aluminum pipe according to claim 7 wherein the alloy for making the pipe blank contains 1.0 to 1.2 mass % of Mn.

9. A process for producing an aluminum pipe according to claim 7 wherein the alloy for making the pipe blank contains up to 0.01 mass % of Cu as an inevitable impurity.

10. A process for producing an aluminum pipe according to claim 7 wherein the alloy for making the pipe blank contains up to 0.25 mass % of Fe as an inevitable impurity.

11. A process for producing an aluminum pipe according to claim 7 wherein the alloy for making the pipe blank contains up to 0.25 mass % of Si as an inevitable impurity.

12. A process for producing an aluminum pipe according to claim 7 wherein the alloy for making the pipe blank contains up to 0.30 mass % of Mg as an inevitable impurity.

13. A process for producing an aluminum pipe according to claim 7 wherein the aluminum material is in the form of a plurality of heat exchange tubes for use in a heat exchanger, each of the heat exchange tubes having 2.0 to 16.0 g/m² of a Zn spray layer formed over a surface thereof, the Zn spray layers of all the heat exchange tubes over the surfaces thereof being 75 to 600 g in combined amount of Zn, the furnace being adapted to braze the heat exchange tubes, aluminum headers and aluminum fins, and the pipe blank is heated when the heat exchange tubes, the headers and the fins are brazed in the inert gas atmosphere.

14. A heat exchanger wherein an aluminum pipe according to any one of claims 1 to 6 is used as each of inlet and outlet tubes.

15. A vehicle provided with a motor vehicle air conditioner comprising a refrigeration cycle wherein a chlorofluorocarbon refrigerant is used and which has a compressor, a condenser and an evaporator, the condenser being a heat exchanger according to claim 14.

16. A refrigeration cycle wherein a chlorofluorocarbon refrigerant is used and which has a compressor, a condenser and an evaporator, the compressor, the condenser and the evaporator being interconnected by piping comprising an aluminum pipe according to any one of claims 1 to 6.

17. A vehicle wherein a refrigeration cycle according to claim 16 is installed as a motor vehicle air conditioner.
